(19) United States
(12) Patent Application Publication
(10) Pub. No.: US 2011/0315096 A1
(43) Pub. Date: Dec. 29, 2011

(54) Gasifier Hybrid combined cycle power plant

(75) Inventors: Bary Wilson, Coconut Creek, FL (US); Brandon Ruf Wilson, Bethell, WA (US); Barry Liss, Pompano Beach, FL (US)

(73) Assignee: ITI Group Corporation, Coral Springs, FL (US)

(21) Appl. No.: 13/134,142

(22) Filed: May 31, 2011

Related U.S. Application Data
(60) Provisional application No. 61/396,669, filed on Jun. 1, 2010.

(51) Int. Cl. F02B 43/08; F01D 1/00

(52) U.S. Cl. 123/3

(57) ABSTRACT

The invention provides a system and method for the efficient, clean and simultaneous conversion of multiple fuels, including but not limited to waste derived gas, liquid and solid phase fuels, to electrical energy. The present invention used a closely coupled combined thermal cycle system based on an air fed gasifier and an internal combustion engine. Steam generated by exhaust heat from an internal combustion engine and from the combustion of syngas produced by the gasifier is used to power an admission steam turbine in an efficient system in which components such as water treatment, heat recovery, and other components are common to gasifier and the internal combustion engine. The invention offers several advantages over other combined cycle power plants employing gasifiers. These advantages include fuel flexibility, efficient operation at generating capacities in the 30 to 120 MW range, commonality of components, and the capability to provide both base load and demand load power from a variety of waste derived fuels.

### FIELD OF THE INVENTION

The present invention relates to the design and application of a clean, efficient hybrid combined cycle system for conversion of solid, liquid, and gas phase waste-derived fuels to electrical energy. More particularly, the present invention relates to simultaneous conversion of multiple fuels, including gas, liquid and solid phase fuels, to generate electricity by use of a combined cycle gasification-based system comprising one or more steam turbine generators driven by steam from boilers heated by exhaust gas from a solid fuel gasifier and an internal combustion engine.

### BACKGROUND OF THE INVENTION

Gasification is a process wherein organic carbonaceous (mainly organic) materials are dissociated at high temperatures in an oxygen-starved thermal reactor to form a gas known as synthesis gas (also designated as syngas, or producer gas). The syngas is composed of mainly carbon dioxide, carbon monoxide, hydrogen, methane, water vapor, as well as trace amounts of sulfur and other oxides.

If the thermal reactor is operated as a gasifier and is air fed (as opposed to oxygen fed only), the syngas stream also contains nitrogen gas. This latter form of syngas, which includes di-molecular nitrogen in relatively large quantities, is more specifically referred to as producer gas. However, according to common usage of terms, the gas phase product from the thermal reactor will be referred to as syngas throughout this application. Compared to combustion or incineration, gasification is an efficient and relatively clean method of converting organic materials to energy.

In conventional integrated gasification combined cycle (IGCC) power generation systems, such as those intended for conversion of a single fuel such as coal, syngas from the gasifier is used to fire one or more combustion gas turbines directly. The hot exhaust gas from the power turbine section of the gas turbine is directed to the gas input of a heat recovery steam generator, (herein referred to as a heat recovery steam boiler), the steam from which is used to drive a steam turbine. This steam turbine is sometimes referred to as the bottom cycle turbine. Mechanical energy from both the gas turbine engine and the bottom cycle steam turbine are used to drive electrical generators to produce electricity.

While this method of using gasifiers in a combined cycle power plant is thermally efficient, its complexity and cost make it impractical for use in systems with generating capacities of less than approximately 300 MW, or when the capability to utilize a variety of different fuels is required. The system is also impractical for use with solid waste derived fuels, which can exhibit inconsistent chemical composition and moisture content over time.

In the overall drive to develop alternative sources of energy from renewable or partially renewable fuels, there is a need for a flexible, adaptable, multi-fuel system that can convert available feedstock combinations in the cleanest and most highly efficient manner possible. Thus, the increasing availability of fuel gasses such as shale gas, landfill gas (and even digester gas) as renewable resources, and the growing recognition of the energy value of solid waste streams, gives rise to increasing need for simple, relatively inexpensive, and reliable small scale (30 MW-150 MW) commercial power plants. To be of most benefit, such power plants need to operate on a varying combination of solid state, liquid state and gas phase fuels as such fuels become available. Such fuels might include, but are not limited to, municipal solid waste, light construction and demolition waste (mostly plastics, including post consumer carpet and wood), source separated commercial waste, shredded used tires, bio-sludge, and creosote treated wooden poles and railroad ties.

The present invention is capable of converting a variety of renewable and non-renewable gaseous, liquid and solid-state fuels to electrical energy in an integrated combined thermal cycle system, preferably comprised of a gasifier-boiler-steam turbine (Rankine cycle) system combined with an internal combustion engine. In the present invention, heat for creating steam used in the steam turbine is obtained from the combustion of syngas from a solid fuel gasifier and the hot exhaust gas from an internal combustion engine, preferably a combustion gas turbine engine. Hot exhaust gasses from these two sources are directed to first and second heat recovery steam boilers.

Both cost reduction and thermal efficiency are gained by disposing the steam turbine, boiler water make-up, boiler water treatment and boiler water pressurization, as well as the gas phase fuel supply as components common to both the gasifier system (first) heat recovery steam boiler and the internal combustion engine (second) heat recovery steam boiler.

### SUMMARY OF THE INVENTION

The present invention is a multi-fuel combined cycle electrical power plant comprised of a gasifier capable of converting a mixture of solid, liquid and gas fuels to clean synthesis gas (or syngas), a gas fuel or liquid fuel fired internal combustion engine such as a gas turbine, heat recovery steam boilers, and an admission steam turbine.

Solid, liquid and/or gaseous state fuels are used to feed one or more gasifiers, the syngas from which is then cleaned in a cyclone and combusted at a temperature below that at which nitrogen oxides (NOₓ) are formed from atmospheric nitrogen. The resulting hot gas is mixed with pre-heated quench air before being directed to the first heat recovery boiler to create steam. Steam from the gasifier-driven (first) heat recovery boiler and steam from the second heat recovery steam boiler, which recovers heat from the internal combustion engine exhaust, are directed to a steam turbine. This steam turbine is preferably an admission steam turbine, which can operate by admission of steam of varying temperatures and pressures onto ports leactes at different stages. The rotational mechanical energy generated by the steam turbine is converted to electrical energy by a steam turbine-driven electrical generator.

In a typical 60 MW generating capacity configuration, operating on solid fuels such as sorted light construction and demolition waste or source separated commercial solid waste, and gas phase fuels such as landfill gas or shale gas, overall combined thermal to electrical energy conversion efficiency is approximately 40%. The invention has been designated as a Gasifier Hybrid Combined Cycle (GHCC) power plant, and is best suited for power generating plants with capacity in the 30 MW to 150 MW range using a variety of waste derived fuels simultaneously.

### BRIEF DESCRIPTION OF THE FIGURES

FIG. 1 is a system schematic diagram illustrating the main components and process streams of the present invention according to the first embodiment of the present invention.

FIG. 2 is a process flow diagram of the present invention showing the interconnections of the process units and various process streams in the present invention in greater detail.

### DESCRIPTION OF THE INVENTION

The following invention disclosure narrative is best understood in light of the attached diagrams, and the illustrative descriptions and examples provided, which comprise a component thereof.

The present invention is an electrical power generating plant for the clean, efficient, simultaneous and concurrent conversion of a variety of gaseous, liquid, and solid state fuels, especially renewable waste derived fuels, to electrical energy. According to the present invention one or more air fed gasifiers are disposed so as to convert solid waste to synthesis gas (syngas or producer gas comprised mainly of carbon monoxide, hydrogen, and methane as fuel components with nitrogen, water and carbon dioxide as non-fuel components). An internal combustion engine (preferably a gas turbine) is disposed in a combined cycle configuration with a steam turbine (preferably a staged steam turbine), with the steam turbine being additionally driven by steam produced by firing of one or more boilers with syngas from the gasifier(s).

Mechanical energy from both the internal combustion engine (gas turbine Brayton cycle engine) and the steam turbine (Rankine cycle engine) are used to drive electrical generators. Through proper sizing of the gas and steam turbines and gasifiers, the system can utilize a wide variety of fuels simultaneously, while maintaining high conversion efficiency.

In one preferred embodiment, renewable shale gas is used to fire the internal combustion engine component, which can be a gas turbine engine or a reciprocating engine. The exhaust from the internal combustion engine is routed to a heat recovery steam boiler, which produces steam to drive a steam turbine.

In this preferred embodiment, the gas turbine internal combustion engine is rated at 30 MW and the heat recovery boiler recovers sufficient thermal energy from the exhaust to produce an additional 10 MW in a steam turbine. However, according to the preferred embodiment of the present invention, the steam turbine is rated at 30 MW. The additional steam required to drive the steam turbine at full capacity is provided by one or more boilers fueled by syngas from one or more gasifiers fueled by sorted municipal solid waste or coal, or bio solids or other suitable solid or liquid or gas state fuels. Thus the total nameplate generating capacity of this preferred embodiment is 70 MW.

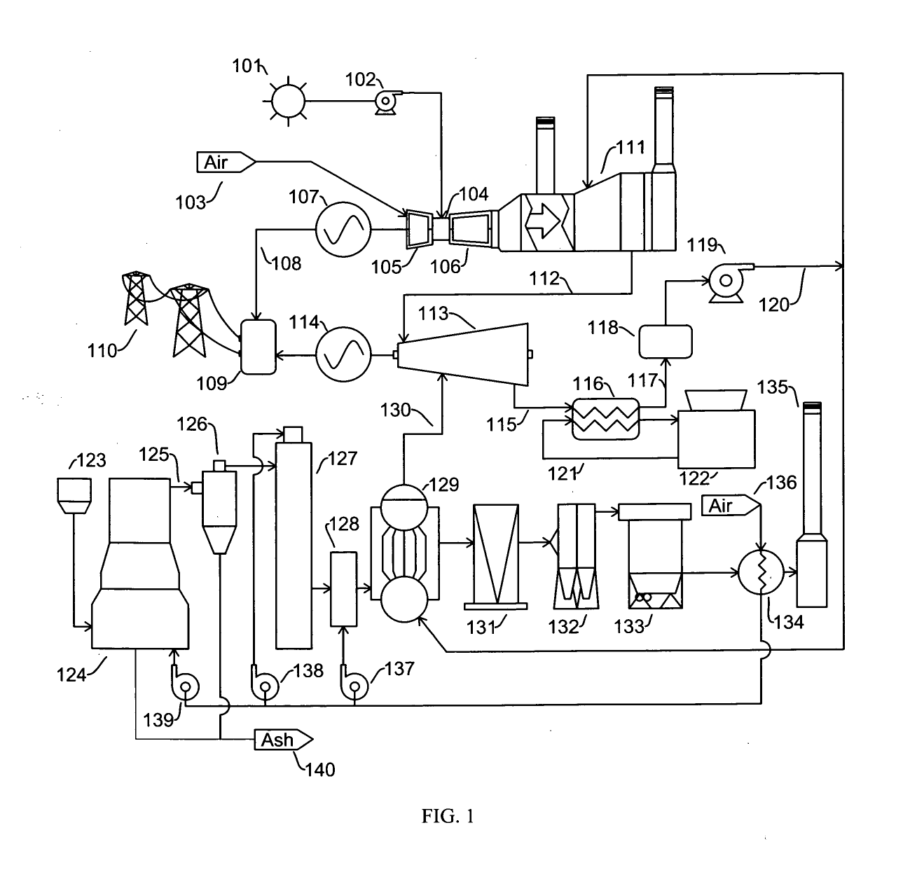

Referring to FIG. 1, a carbonaceous fuel gas such as methane, shale gas, or natural gas 101, is compressed by a compressor or pump 102 to bring the fuel gas to the proper pressure for introduction into the gas turbine combustor 104. Ambient air 103 is compressed in the compressor turbine section 105 of a Brayton cycle heat engine and enters the combustor 104. The power turbine 106 of the same engine powers the first generator 107 and a conductor 108 carries electrical power to an electrical grid intertie transformer 109, which transfers the electrical power to the electrical grid 110 at the proper voltage and phase.

Hot exhaust from the gas turbine power turbine 106 passes through a heat recovery steam boiler 111 that generates high pressure steam 112, which is routed to a steam turbine 113. The steam turbine 113 powers a second generator 114 that supplies electrical energy to the grid intertie transformer. Wet, low pressure steam 115 is discharged from the steam turbine and is condensed by a condenser 116. The resulting condensate 117 is treated by a water treatment system 118, and re-pressurized by a pump 119. The treated, pressurized condensate 120 is then returned to the heat recovery steam boiler 129 and heat recovery steam boiler 111.

A solid fuel feed supply 123 is fed into a gasifier 118 that produces syngas 125. The syngas enters a hot cyclone 126, which removes particulate matter from the syngas 125.

Bottom ash from the gasifier and particulate matter from the cyclone are collected a in a suitable container 140 and removed. The syngas then enters the combustion tube 127, where it is partially oxidized in a manner so as not to increase the combustion temperature above 2,600 degrees F. thus avoiding the formation of NOₓ. The partially oxidized syngas then enters the re-oxidation unit and quench chamber 128 where it is mixed with preheated excess air to complete oxidation and with hot exhaust gas in quenching chamber 128, where oxidized syngas is quenched to an appropriate temperature to fire the heat recovery boiler 129. Heat recovery boiler 129 generates high pressure steam 130. Exhaust or flue gas leaving the boiler is processed by an acid gas removal system 131, an electrostatic precipitator 132, and a baghouse 133 to ensure that discharged gas is suitably clean for release into atmosphere. A heat exchanger 134 uses the exhaust gas to preheat ambient air 136. The preheated air then supplied an air feed pump, 137, for the re-oxidation chamber, an air feed pump, 138, for the oxidation tube and an air feed pump, 139, for the gasifier underfire air. The exhaust gas is discharged into the atmosphere through a stack 135.

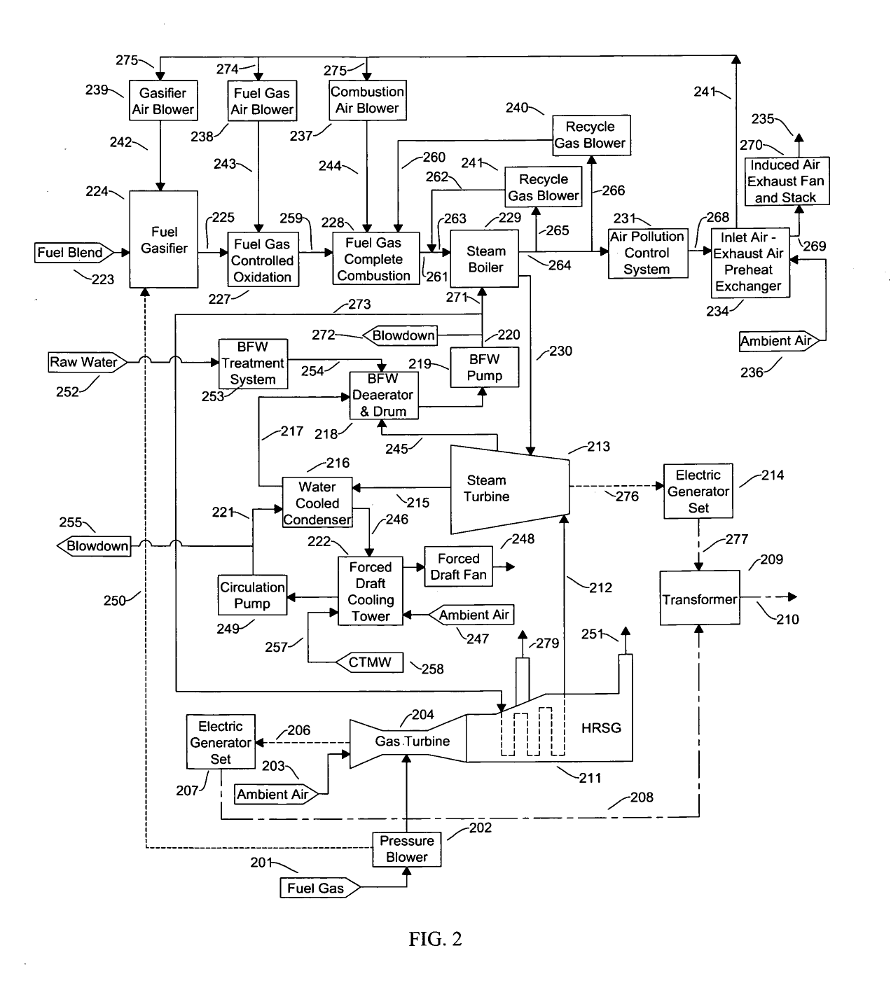

FIG. 2 is a more detailed process flow diagram of the present invention and illustrates in more detail the function of an integrated gasification hybrid combined cycle power plant according to principles of the present invention.

In this preferred embodiment, a source 201 of treated shale gas provides fuel for the gas turbine combined cycle subsystem, as well as the supplemental and start-up fuel for the solid waste to energy subsystem. Fuel from source 201 can also be used to maintain the gasifier in hot standby when needed. Fuel gas is compressed in pressure blower 202 and fed to the gas turbine section 204 of the gas turbine combined cycle subsystem as well as to the fuel gasifier thermal reactor 224 as required. Combustion air is compressed in pressure blower 203 and fed to the gas turbine section 204 of the gas turbine combined cycle subsystem. Boiler feed water 220 from boiler feed water pump 219 is fed into the heat recovery steam generator 211 and is converted to superheated steam 212 which is fed to the steam turbine 213 inlet.

Mechanical energy is transmitted from the gas turbine through 206 to an electric generator set 207. The electrical energy output of generator set 207 is transmitted via 208 to transformer 209 for transmittal to its users via the electrical power grid 210.

A flue gas exhaust chimney with a damper 278 is located in between the gas turbine 204 and heat recovery steam generator 211. Flue gas 250 is discharged to the atmosphere through an exhaust stack on the top of the heat recovery steam generator 211.

Steam turbine 213 also receives steam 230 from heat recovery boiler 229 disposed so as to extract heat from the combustion of syngas produced by the gasifier 224. A small portion of the steam (245) in steam turbine 213 is extracted and used to deaerate and preheat the steam condensate in deaerator and drum 218. The mechanical energy developed is transmitted from the steam turbine through 276 into an electric generator 214. The electric power generated in 214 is transmitted through 277 to transformer 206 and then to users via the power grid 210.

The wet steam 215 exiting the steam turbine 213 is condensed in a water cooled heat exchanger 216 with condensate 217 draining to the boiler feed water deaerator and drum 218. Make up boiler feed water 254 is prepared by pretreatment of river, well or municipal water 252 in water treatment unit 253 and fed to the dearator's drum 218. The boiler feed water pump 219 discharge 220 is distributed in three steams; stream 271 provides boiler feed water for heat recovery steam boiler 229 of the waste to energy gasification subsystem of the present invention, stream 272 provides boiler feed water for the heat recovery steam boiler 211 disposed so as to extract heat from exhaust of the gas turbine 204, and stream 273 is the blow down to the sanitary sewer required to prevent boiler fouling.

Make up water 257 for the cooling tower 222 is prepared by pre-treating river, well or municipal water 256 in filter 258. Cooling tower 222 circulating water 221 is pumped in 249 and fed to the steam turbine condenser 216 to extract the heat from the wet steam 215 necessary for complete condensing of the steam to occur. A portion of the cooling tower circulating flow 221 is the blow down 255 which is discharged to the sanitary sewer to minimize cooling tower fouling. The heated cooling water 246 is fed to the top of the cooling tower 222. Ambient air 247 is drafted near the base of the cooling tower 222 and exhausts saturated with moisture to the atmosphere through draft fan 248 carrying with it the waste heat from evaporative cooling of the circulating cooling water.

Fuel 223 is fed to the fuel gasifier 224 in which it is gasified with sub-stoichiometric underfire air 242 that has been compressed sufficiently in air blower 239 to overcome the gasifier's air distribution system pressure drop requirement. Fuel gas 225 exiting the gasifier is partially combusted in the fuel gas controlled oxidation unit (combustor tube 227) with sub-stoichiometric air 243 that has been compressed sufficiently in air blower 238 to overcome the fuel gas controlled oxidation unit's air distribution system pressure drop requirement. Fuel gas 259 is fully combusted with excess air 244 that has been compressed sufficiently in air blower 237 to overcome the combustor's air distribution system pressure drop requirement.

Control of the fuel gas re-oxidation unit 228 temperature is achieved by recycle flue gas 260 injection with the recycle flue gas having been compressed sufficiently in gas blower 240 to overcome the combustor's air distribution system pressure drop requirement. The temperature of the flue gas 261 exiting the fuel gas complete combustion system 228 is reduced, by adding a second recycle gas 263, said second recycle gas having been compressed sufficiently in gas blower 241 to overcome the combustor's air distribution system pressure drop requirement to a level required, to comply with boiler super heater section tube metallurgical limitations.

The flue gas exhaust from the boiler 264 is divided into three streams; flue gas recycle 265 which provides boiler 229 flue gas inlet temperature control, flue gas recycle 266 which provides complete combustion unit 228 temperature control, and flue gas exhaust 267 which is treated in the air pollution control system 231 of the facility. The flue gas exhaust 268 from unit 231 enters the inlet air—exhaust air preheat exchanger 234 and provides the energy to preheat inlet ambient air 236. The cooled flue gas 269 is drawn through induced air exhaust fan and then discharged to the atmosphere through an exhaust stack 270 as stream 235. The preheated ambient air stream 241 is divided into three streams; stream 273, which provides underfire air stream, which 274 provides overfire air and stream 275, which provides excess combustion air.

The invention has been designated a Gasifier Hybrid Combined Cycle (GHCC), power plant because, unlike conventional integrated gasifier combined cycle systems, the syngas from the gasifiers is used to produce steam to drive the steam turbine instead of being cooled and used to fire a gas turbine. The hybrid designation is also applicable because steam used in the Rankine cycle portion of the combined cycle is produced both by combustion of syngas and by heat recovery from the hot exhaust gas from the internal combustion engine (in this case, a gas turbine).

The present invention is much less complex and more flexible than a conventional IGCC system and can be economically deployed at much lower generating capacities. Whereas IGCC is not economical at generating capacities of less than approximately 300 MW, the GHCC system of the present invention can be economically deployed at generating capacities of as little as 30 MW.

### APPLICATION EXAMPLE OF THE PRESENT INVENTION

As an example of a preferred embodiment, the fuel gas to be converted is a limited amount of biogenic gas, the solid state fuel to be converted is a combination of sorted municipal solid waste, light construction and demolition waste, and shredded waste tires.

Shale gas (ca 930 BTU/cf) is recovered from shale gas wells (101), de-humidified, compressed (102) and provided to a 30 MW gas turbine (104, 105, 106) at a rate of approximately 7 MMCF/day. The gas turbine converts the shale gas to electrical energy by means of the first electrical generator at an efficiency of approximately 37%. Hot exhaust gas from the gas turbine enters a heat recovery steam boiler (111) at a temperature of approximately 900 degrees F. and at a rate of approximately 440,000 lb/hr.

Condensate and feed water (120) are pumped through the heat exchanger water tubes of the heat recovery boiler and emerges as steam at high pressure and temperature. This steam (112), is routed to the first stage of a two stage admission steam turbine 113, where it accounts for approximately 10 MW of the electrical power generated by the steam turbine generator (114).

In a first 10 MW gasifier reactor (124), a mixture of sorted municipal solid waste, bio-sludge and shredded tires held in hopper 123 is gasified to produce a mixture of carbon monoxide, hydrogen and methane, as well as nitrogen, water and carbon dioxide. This gas is designated as producer gas or synthesis gas (here syngas). The syngas is extracted to a high temperature cyclone (126), which removes more than 90% of the particulate material. Thereafter the syngas (125) is oxidized in a combustion tube (127) at a temperature that is maintained below 2,500 degrees F. to avoid the formation of nitrogen oxides (NOₓ) from atmospheric nitrogen during the combustion process. The hot gas mixture resulting from the combustion of the syngas is then directed to a re-oxidation (128) unit where combustion is completed by the addition of pre-warmed ambient air and quenched with hot recycled flue gas supplied via blower 137 and routed to the heat recovery steam boiler (129).

Steam (130) from the first heat recovery steam boiler, at an appropriate pressure and temperature (approximately 720 degrees F. and approximately 720 psig), is routed to the steam turbine (113) and injected into the turbine stage at which the lower pressure admission port is located. Electrical generator 107 driven by the gas turbine (104, 105, 106), and electrical generator (114) driven by the steam turbine (113) produce electricity that is routed to the grid intertie transformer (108). The heat recovery boiler 129 connected to the gasifier system (124, 126, 127, 128) is operated at a gas inlet temperature that does not exceed approximately 1400 degrees F., in order to avoid fouling of the boiler tubes by exceeding the melting temperature of any particulate matter remaining in the combusted syngas.

The power plant in the present example is comprised of three 10 MW gasifier modules and a 30 MW gas turbine with an associated 15 MW heat recovery steam boiler and steam turbine for a total plant generating capacity of 75 MW.

### ADVANTAGES OF THE PRESENT INVENTION

As a gasification-based combined cycle system, the present invention has a number of advantages over conventional solid waste incineration-based steam turbine power plants that also use combustion turbines for converting landfill gas to electrical energy. The present invention also has advantages over integrated gasification combined cycle (IGCC) power generation such as those developed for conversion of coal to electrical energy.

Gasification as a means of converting solid waste for production of electrical energy has been slow to develop, in part, because of the relatively low energy density (calorific value) of many of the waste materials commonly used for fuel, especially inadequately sorted or prepared municipal solid waste. Development of a variety of energy rich (relatively high BTU) feed stocks from selected solid waste materials that can enhance the average calorific value of fuel for gasifiers used in the conversion of a various solid waste materials, is an important aspect of improving the performance and applicability of gasification technology, and is an important factor in realizing full advantage of the present invention.

When proper solid waste fuel selection, formulation, and preparation is carried out (such as shredding or pelletizing), waste fuel higher heating values (or HHV; calorific value of the moisture free material) can exceed 9,000 BTU/lb, for example. Together with gasification's inherent efficiency and reduction in particulate and oxidative pollutant production as compared to incineration, proper formulation for gasification allows the power plant of the present invention to produce far fewer solid and gas phase emissions from the conversion of solid waste to energy as compared to an incinerator, especially an incinerator operated in “bulk burn” mode.

Advantages of the present invention as compared to the above mentioned IGCC process are as follows. In the IGCC process, the syngas must be cleaned and cooled before it can be introduced into the gas turbine, thus wasting much of the enthalpy with which the hot syngas emerged from the gasifier. In the present invention, the syngas need not be cooled before use. Enthalpy thus preserved and maintained in the syngas contributes to the creation of steam in the first heat recovery steam boiler. This steam is then used to drive a reliable and efficient steam turbine, which in turn powers a second electrical generator.

While it is designed to operate primarily as a base load system, one or more additional gas turbines or reciprocating engine generators can be installed in the power plant and used for demand load following or peak shaving. Peak shaving can also be achieved by operating the gas turbine in single cycle mode, or by ancillary duct firing of the heat recovery steam boiler with a fuel gas. Duct firing can increase the heat recovery steam boiler output by between 10% to 20% (thermal). (Duct firing is a method whereby hot gasses of gas state fuel is admitted to a heat recovery steam boiler through an ancillary duct separate from the main gas inlet. Duct firing increases the steam production capacity of the heat recovery steam generator is generally used on an as-needed basis for peak shaving.)

Another advantage of the present invention over conventional IGCC is that it can be readily deployed to convert multiple fuels to electricity. In contrast, IGCC operates on a single fuel only (such as coal) and employs an air separation plant that provides the gasifier with pure oxygen, while providing nitrogen as an energy transfer medium for the power turbine. Energy requirements for the air separation plant represent a significant parasitic power load for the IGCC system. For smaller capacity gasification systems to be used in converting a mixture of waste derived renewable energy fuels (such as municipal solid waste, and landfill gas, and bio-solids for example), use of pure oxygen fed gasifiers, with their attendant and expensive gas separation plants, is not practical.

Unlike conventional IGCC or gas turbine combined cycle (GTCC or CCGT), the present invention can operate on a wide variety of solid, liquid and gas state fuels such as those often resulting from formulation of waste derived fuel combinations from a variety of waste sources. This gives the present invention great flexibility in exploiting various fuels, thus allowing it to be economically viable in situations where a variety of inexpensive waste fuels are available, but in limited quantities. Gas state fuels in such combinations might include landfill gas, shale gas, digester gas, and hydrocarbon gasses associated with oil recovery and oil refining that might otherwise be simply flared. Solid fuels in such combinations might include light construction and demolition waste (mostly plastic and wood), waste coal (coal gob), agricultural waste, wood waste and biomass, bio-solids, shredded tires, municipal solid waste, railroad ties or poles that have been treated with creosote, among other materials.

Gasifiers can serve to reduce solid waste volume by converting most of the carbon in these materials to energy. Waste volume reduction for the gasification unit of the present invention is approximately 95%. Gasifiers can therefore be economically operated on fuels of low calorific value, provided that the commercial value in solid waste reduction can be accrued to operation of the gasifier. Converting such low calorific value waste can require the addition of higher BTU ancillary fuels. In the present invention, several higher BTU fuels can be blended with lower BTU fuels to increase overall BTU value of various fuel combinations.

The present invention is much less complex and more flexible than a conventional IGCC power plant and can be economically deployed at much lower generating capacities. Whereas IGCC is not economical at generating capacities of less than approximately 300 MW, the GHCC system of the present invention can be economically deployed at generating capacities of as little as 30 MW up to 150 MW.

Another advantage of the present invention is adaptability. The gasifiers of the present invention are designed in 10 MW (nameplate) modules. While these 10 MW modules can be used in a standalone mode, it is more efficient and cost effective to deploy the gasifer modules as a basic 30 MW system (3 modules) with a combustion turbine generator combined cycle unit having a generating capacity of 30 MW or more, bringing the capacity of the overall power plant to 60 MW or more. As an example of this flexibility, such a power plant could be deployed to operate on a combination of shale gas and landfill gas while also gasifying waste coal (coal gob) or other solid waste that would otherwise go to landfill. In such an application, the invention recovers energy from the materials that would otherwise go to landfill, while reducing both landfill volume and reducing greenhouse gas emission from landfills.

Modular 10 MW gasifier units can be added to a basic power plant as new waste fuel sources become available. Additional steam turbines can be installed as needed and be driven by steam from additional 10 MW gasifier modules. These individual modules can be designed to operate on specific solid fuel mixes if needed.

Thus, fuel flexibility is an important advantage of the present invention. As described in the application example, it allows conversion of a variety of waste fuels as well as conventional fuels such as coal and natural gas in a uniformly clean and highly efficient manner.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

We claim

1. A method for the generating electricity from multiple fuels using at least one gasifier, at least one internal combustion engine driven electrical generator and at least one steam turbine driven electrical generator in a combined cycle configuration, said method being comprised of the following steps:
preparing and transferring solid carbonaceous fuel to the pre-heated first reaction chamber of an air fed gasifier gasifier;
operating said air fed gasifier by means of controlling fuel feed rate, introduction of air and introduction of fuel and water into a pre-heated first chamber so as to generate hot syngas, said syngas being combusted in a combustion tube second chamber, and in a subsequently disposed reoxidizer;
extracting the hot gases generated by combustion of said syngas into a first heat recovery steam boiler so as to produce high pressure steam;
conveying the steam produced in the first heat recovery steam boiler to drive a steam turbine, preferably a staged admission steam turbine, which is disposed so as to drive a first electrical generator;
preparing and transferring a gas or liquid phase fuel to an internal combustion engine disposed so as to drive a second electrical generator;
extracting the hot gas produced by combustion of said liquid or gas fuel in the internal combustion engine into a second heat recovery steam boiler to produce high pressure steam;
conveying the steam produced in the second heat recovery steam boiler to drive said steam turbine, preferably a staged admission steam turbine, disposed so as to drive an electrical generator;
transferring the low pressure wet steam from said admission steam turbine to a condenser to recover liquid water, re-pressuring the condensate, together with required make-up or feed water, and introducing the water, under pressure into the input of the first and second heat recovery steam boilers;
routing the flue gas from the first and second heat recovery boilers to appropriate flue gas clean-up process trains before release into the environment.
routing the electrical current from the first and second electrical generators to the primary of a transformer, the secondary of which is connected to the electrical power grid;

2. The method according to claim 1 wherein the fuel used in the apparatus is derived from at least one of postconsumer or postindustrial solid waste, liquid waste or gas waste.

3. The method according to claim 1 wherein the gas phase fuel mixture for the generation of electricity results from the anaerobic digestion or decomposition of carbonaceous materials.

4. The method according to claim 1 wherein the solid fuel mixture for use in the gasifier is formulated such that the calorific value (higher heating value) of the solid fuel is at least 8,000 BTU/lb.

5. The method according to claim 1 wherein the solid fuel mixture for use in the gasifier is formulated to a calorific value (higher heating value) of at least 8,000 BTU/lb by means of addition of at least one of: tire shreds, plastic, waste oil, methane rich gas, creosote treated waste wood. or other high energy content waste material.

6. The method according to claim 1 wherein all, or a portion of, the syngas or the hot syngas combustion product from the gasifier is directed to the (second) heat recovery steam boiler connected to the internal combustion engine as an ancillary heat source or for duct firing of said second heat recovery steam boiler.

7. An apparatus for the simultaneous conversion of at least one carbonaceous solid fuel and at least one liquid fuel or at least one gas phase fuel to electricity, the apparatus comprising:
at least one heated gasifier thermal reactor (first chamber) that produces a synthesis (syngas) from the thermal decomposition of a carbonaceous fuel in a reducing atmosphere;
at least one combustion tube (second chamber) in which the synthesis gas from said gasifier reactor (first chamber) is oxidized at a temperature that does not exceed 2,600 degrees F.,
at least one syngas re-oxidation and quench unit wherein the combustion of said syngas is completed and the temperature of the combustion product gas is controlled for admission to a first heat recovery steam boiler
at least one internal combustion engine that operates on gas or liquid phase fuel;
at least one (second) heat recovery boiler that produces high pressure steam from the exhaust heat generated by the combustion of liquid or gas phase fuels in said internal combustion engine;
at least one steam turbine, preferably an admission steam turbine;
at least one steam turbine driven electrical generator;
at least one internal combustion engine driven electrical generator;
a boiler water make up means;
a boiler water treatment means
a boiler water pumping means;
a steam turbine ejection steam condensation means;
an apparatus status monitoring and control means.

8. The apparatus according to claim 7 wherein the gasifier unit is comprised of:
a means of delivering solid fuel into a heated gasification reactor (first chamber);
at least one first reaction chamber into which fuel and air are admitted in a sub-stochiometric ratio for combustion so as to produce syngas;
at least one cyclone for the removal of particulate matter of the syngas exiting the gasification reactor (first chamber);
at least one combustion tube (second chamber) for incomplete or complete combustion of said syngas;
at least one re-oxidation unit to complete the combustion and/or reoxidation of the syngas and for the admission of quench air to control the temperature of hot combustion product gas entering the heat recovery boiler;
at least one heat exchanger for extracting heat from the flue gas for pre-heating of the quench air.

9. The apparatus according to claim 7 wherein at least one heat recovery steam boiler is connected to the re-oxidation unit of said gasifier and disposed so as to produce high pressure steam from the heat generated by the combustion of syngas gas in the combustion tube (second chamber) and re-oxidizer of the gasifier;

10. The apparatus according to claim 7 wherein said heat recovery boiler is comprised of a water tube superheater, water tube heat exchanger boiler, an economizer, and is disposed with a flue gas clean up train comprising at least one of:
acid gas removal unit,
electrostatic precipitator,
baghouse,
baghouse with carbon and lime injection, and an exhaust gas stack.

11. The apparatus according to claim 7 wherein the components are so disposed such that the gas turbine drives an electrical generator.

12. Apparatus according to claim 7 wherein and heat produced by both the gas turbine and the combustion of the syngas from the gasifier is used to make steam that drives one or more steam turbine electrical generators.

13. The apparatus according to claim 7 wherein the steam turbine is an admission steam turbine capable of operating with the simultaneous input of steam of different temperatures and pressures at different stages or admission ports along the steam expansion path.

14. The apparatus according to claim 7 wherein the internal combustion engine is a gas turbine engine.

15. The apparatus according to claim 7 wherein the combustion gas turbine engine can be operated in either the combined cycle or single cycle mode.

16. The apparatus according to claim 7 wherein the internal combustion engine is a reciprocating engine.

17. The apparatus according to claim 7 wherein the gasification system and the internal combustion engine share a common fuel gas source.

18. The apparatus according to claim 17 wherein the common source of gas fuel is used for gasifier start-up and maintaining gasifier hot standby.

19. The apparatus according to claim 7 wherein steam from the heat recovery boiler heated by hot gasses from the gasifier combustion tube (second chamber) and the steam from the heat recovery boiler heated by the exhaust gas from the internal combustion engine are directed to a common admission steam turbine generator.

20. The apparatus according to claim 7 wherein the solid waste fuel for the gasifier is a solid mixture having a calorific value of at least 8,000 BTU/lb.
